(19) United States
(12) Patent Application Publication
(10) Pub. No.: US 2021/0295875 A1
(43) Pub. Date: Sep. 23, 2021

(54) TOUCH PANEL BASED VIDEO EDITING

(71) Applicant: Justin Garak, Toronto (CA)

(72) Inventor: Justin Garak, Toronto (CA)

(21) Appl. No.: 17/266,561

(22) PCT Filed: Aug. 7, 2019
(86) PCT No.: PCT/US2019/045584

§ 371 Date: Feb. 5, 2021

Related U.S. Application Data
(60) Provisional application No. 62/715,711, filed on Aug. 7, 2018.

(51) Int. Cl. G11B 27/34; G06F 3/0488; G11B 27/031

(52) U.S. Cl. CPC G11B 27/34; G11B 27/031; G06F 3/0488

(57) ABSTRACT

A system configured for editing video on a mobile device is disclosed. A touch panel can be used to select and trim a video file. In an embodiment, changing a start time of the video file causes an end time of the video file to be automatically selected based on a selected duration of the trimmed video file, and vice versa.

### BRIEF DESCRIPTION OF THE DRAWINGS

FIG. 1 depicts a diagram of an example of a system for touch panel based video edits.

FIG. 2 depicts a diagram of an example of a touch panel based video trimming system.

FIG. 3 depicts a diagram of an example of a trimmed video player system.

FIG. 4A and FIG. 4B depict examples of a touch panel user interface for selecting and trimming a video file.

FIG. 5 depicts a flowchart of an example method for selecting and trimming a video file.

FIG. 6 depicts an example of a touch panel user interface for synchronously previewing image and audio contents of a video file.

FIG. 7 depicts an example of a touch panel user interface for synchronously previewing script and audio contents of a video file.

FIG. 8 depicts an example of a touch panel user interface for synchronously previewing image and script contents of a video file.

FIG. 9 depicts an example of a touch panel user interface for selecting an operation to be performed on a touch panel based video trimming system.

FIG. 10 depicts an example of a user interface for selecting a video file to playback on a trimmed video player system.

FIG. 11 depicts an example of a user interface for concurrently playing a video file and reviewing image contents of the video file.

FIG. 12 depicts an example of a user interface for adjusting an aspect ratio of a screen to playback a video file.

### DETAILED DESCRIPTION

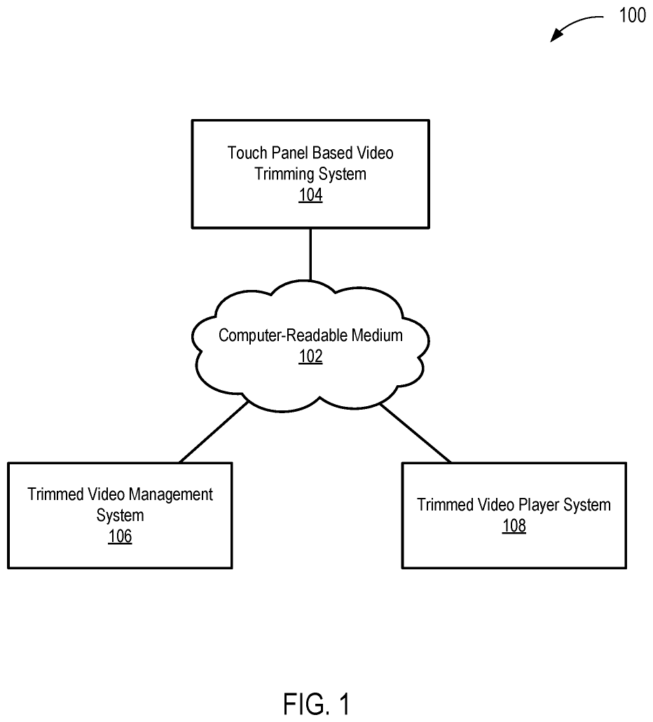

FIG. 1 shows a diagram 100 of an example of a system for touch panel based video edits. The example system shown in FIG. 1 includes a computer-readable medium 102, a touch panel based video trimming system 104, a trimmed video management system 106, and a trimmed video player system 108.

In the example of FIG. 1, the touch panel based video trimming system 104, the trimmed video management system 106, and the trimmed video player system 108 are coupled to the computer-readable medium 102. As used in this paper, a “computer-readable medium” is intended to include all mediums that are statutory (e.g., in the United States, under 35 U.S.C. 101), and to specifically exclude all mediums that are non-statutory in nature to the extent that the exclusion is necessary for a claim that includes the computer-readable medium to be valid. Known statutory computer-readable mediums include hardware (e.g., registers, random access memory (RAM), non-volatile (NV) storage, to name a few), but may or may not be limited to hardware.

The computer-readable medium 102 is intended to represent a variety of potentially applicable technologies. For example, the computer-readable medium 102 can be used to form a network or part of a network. Where two components are co-located on a device, the computer-readable medium 102 can include a bus or other data conduit or plane. Where a first component is co-located on one device and a second component is located on a different device, the computer-readable medium 102 can include a wireless or wired back-end network or LAN. The computer-readable medium 102 can also encompass a relevant portion of a WAN or other network, if applicable.

The computer-readable medium 102 and other applicable systems or devices described in this paper can be implemented as a computer system, a plurality of computer systems, or parts of a computer system or a plurality of computer systems. In general, a computer system will include a processor, memory, non-volatile storage, and an interface. A typical computer system will usually include at least a processor, memory, and a device (e.g., a bus) coupling the memory to the processor. The processor can be, for example, a general-purpose central processing unit (CPU), such as a microprocessor, or a special-purpose processor, such as a microcontroller.

The memory can include, by way of example but not limitation, random access memory (RAM), such as dynamic RAM (DRAM) and static RAM (SRAM). The memory can be local, remote, or distributed. The bus can also couple the processor to non-volatile storage. The non-volatile storage is often a magnetic floppy or hard disk, a magnetic-optical disk, an optical disk, a read-only memory (ROM), such as a CD-ROM, EPROM, or EEPROM, a magnetic or optical card, or another form of storage for large amounts of data. Some of this data is often written, by a direct memory access process, into memory during execution of software on the computer system. The non-volatile storage can be local, remote, or distributed. The non-volatile storage is optional because systems can be created with all applicable data available in memory.

Software is typically stored in the non-volatile storage. Indeed, for large programs, it may not even be possible to store the entire program in the memory. Nevertheless, it should be understood that for software to run, if necessary, it is moved to a computer-readable location appropriate for processing, and for illustrative purposes, that location is referred to as the memory in this paper. Even when software is moved to the memory for execution, the processor will typically make use of hardware registers to store values associated with the software, and local cache that, ideally, serves to speed up execution. As used herein, a software program is assumed to be stored at an applicable known or convenient location (from non-volatile storage to hardware registers) when the software program is referred to as “implemented in a computer-readable storage medium.” A processor is considered to be “configured to execute a program” when at least one value associated with the program is stored in a register readable by the processor.

In one example of operation, a computer system can be controlled by operating system software, which is a software program that includes a file management system, such as a disk operating system. One example of operating system software with associated file management system software is the family of operating systems known as Windows® from Microsoft Corporation of Redmond, Wash., and their associated file management systems. Another example of operating system software with its associated file management system software is the Linux operating system and its associated file management system. The file management system is typically stored in the non-volatile storage and causes the processor to execute the various acts required by the operating system to input and output data and to store data in the memory, including storing files on the non-volatile storage.

The bus can also couple the processor to the interface. The interface can include one or more input and/or output (I/O) devices. The I/O devices can include, by way of example but not limitation, a keyboard, a mouse or other pointing device, disk drives, printers, a scanner, and other I/O devices, including a display device. The display device can include, by way of example but not limitation, a cathode ray tube (CRT), liquid crystal display (LCD), or some other applicable known or convenient display device. The interface can include one or more of a modem or network interface. It will be appreciated that a modem or network interface can be considered to be part of the computer system. The interface can include an analog modem, ISDN modem, cable modem, token ring interface, Ethernet interface, satellite transmission interface (e.g. “direct PC”), or other interfaces for coupling a computer system to other computer systems. Interfaces enable computer systems and other devices to be coupled together in a network.

The computer systems can be compatible with or implemented as part of or through a cloud-based computing system. As used in this paper, a cloud-based computing system is a system that provides virtualized computing resources, software and/or information to client devices. The computing resources, software and/or information can be virtualized by maintaining centralized services and resources that the edge devices can access over a communication interface, such as a network. “Cloud” may be a marketing term and for the purposes of this paper can include any of the networks described herein. The cloud-based computing system can involve a subscription for services or use a utility pricing model. Users can access the protocols of the cloud-based computing system through a web browser or other container application located on their client device.

A computer system can be implemented as an engine, as part of an engine, or through multiple engines. As used in this paper, an engine includes one or more processors or a portion thereof. A portion of one or more processors can include some portion of hardware less than all of the hardware comprising any given one or more processors, such as a subset of registers, the portion of the processor dedicated to one or more threads of a multi-threaded processor, a time slice during which the processor is wholly or partially dedicated to carrying out part of the engine's functionality, or the like. As such, a first engine and a second engine can have one or more dedicated processors, or a first engine and a second engine can share one or more processors with one another or other engines. Depending upon implementation-specific or other considerations, an engine can be centralized or its functionality distributed. An engine can include hardware, firmware, or software embodied in a computer-readable medium for execution by the processor. The processor transforms data into new data using implemented data structures and methods, such as is described with reference to the FIGS. in this paper.

The engines described in this paper, or the engines through which the systems and devices described in this paper can be implemented, can be cloud-based engines. As used in this paper, a cloud-based engine is an engine that can run applications and/or functionalities using a cloud-based computing system. All or portions of the applications and/or functionalities can be distributed across multiple computing devices, and need not be restricted to only one computing device. In some implementations, the cloud-based engines can execute functionalities and/or modules that end users access through a web browser or container application without having the functionalities and/or modules installed locally on the end-users' computing devices.

As used in this paper, datastores are intended to include repositories having any applicable organization of data, including tables, comma-separated values (CSV) files, traditional databases (e.g., SQL), or other applicable known or convenient organizational formats. Datastores can be implemented, for example, as software embodied in a physical computer-readable medium on a general- or specific-purpose machine, in firmware, in hardware, in a combination thereof, or in an applicable known or convenient device or system. Datastore-associated components, such as database interfaces, can be considered “part of” a datastore, part of some other system component, or a combination thereof, though the physical location and other characteristics of datastore-associated components is not critical for an understanding of the techniques described in this paper.

Datastores can include data structures. As used in this paper, a data structure is associated with a particular way of storing and organizing data in a computer so that it can be used efficiently within a given context. Data structures are generally based on the ability of a computer to fetch and store data at any place in its memory, specified by an address, a bit string that can be itself stored in memory and manipulated by the program. Thus, some data structures are based on computing the addresses of data items with arithmetic operations; while other data structures are based on storing addresses of data items within the structure itself. Many data structures use both principles, sometimes combined in non-trivial ways. The implementation of a data structure usually entails writing a set of procedures that create and manipulate instances of that structure. The datastores, described in this paper, can be cloud-based datastores. A cloud based datastore is a datastore that is compatible with cloud-based computing systems and engines.

In the example of FIG. 1, the touch panel based video trimming system 104 is intended to represent a hardware system configured to perform touch panel based video edits including video trimming. The functionality of the touch panel based video trimming system 104 can be implemented by one or more touch panel mobile computing devices (e.g., smartphones, cell phones, smartwatches, tablet computers, laptop computers, and the like) or other computing devices. As used in this paper, touch panel based video edits include applicable edits of a video file performed in accordance with touch panel user operations, in particular, video trimming, content insertion, effect addition, video preview, and so on. A video trimming refers to deletion of a part of a sequence of frame images of video contents to shorten the timeline of the video. The trimmed part may be an initial portion, an intermediate portion, or an end portion of video contents. A content insertion refers to insertion of media contents (e.g., video, images, or audio) into video contents of a video file. An effect addition refers to addition of graphical or audio effects to video contents of a video file. The graphical or audio effects may include frame rate change (e.g., stop motion effect), color effect (e.g., black and white), resolution change (e.g., to lower resolution), background sound, dubbing (e.g., addition of local language), etc. A video preview refers to preview of video, audio, and/or script contents of a video file for identifying video contents to be changed by trimming, insertion, addition, and so on. According to touch panel operations enabled by user interfaces displayed on a touch panel associated with the touch panel based video trimming system 104, the touch panel based video edits can be carried out more easily with simpler user operations.

In the example of FIG. 1, the trimmed video management system 106 is intended to represent a hardware system configured to manage video files, including video files uploaded from the touch panel based video trimming system 104. The functionality of the trimmed video management system 106 can be implemented by one or more server computing systems. Those server computing systems may be a dedicated computing system for providing the service for managing video files, or a distributed computing system provided as an IaaS, PaaS, or SaaS by a third party service provider. In a specific implementation, in managing video files, the trimmed video management system 106 provides user accounts and associated space for users of the touch panel based video trimming systems 104 to upload video files, and provides a website or a web-based application for viewers to access for playing back the video files. In a specific implementation, in managing video files, the trimmed video management system 106 may also provide applications for users of the touch panel based video trimming systems 104 to perform touch panel based video edits, and provide application for users of the trimmed video player systems 108 to playback uploaded video files.

In the example of FIG. 1, the trimmed video player system 108 is intended to represent a hardware system configured to playback video files made accessible by the trimmed video management system 106. The functionality of the trimmed video player system 108 can be implemented by one or more computing devices (e.g., smartphones, cell phones, smartwatches, tablet computers, laptop computers, desktop computers, and the like) or other computing devices. In a specific implementation, the trimmed video player system 108 is implemented by a touch panel computing device, and in that case the trimmed video player system 108 may perform a touch panel based video playback. As used in this paper, touch panel based video playback includes applicable review of a video file performed in accordance with touch panel user operations. In a specific implementation, the touch panel based video playback includes a concurrent video playback and frame image contents review as discussed below in this paper. According to touch panel operations enabled by user interfaces displayed on a touch panel associated with a trimmed video player system 108, a new user experience on video playback can be provided to users.

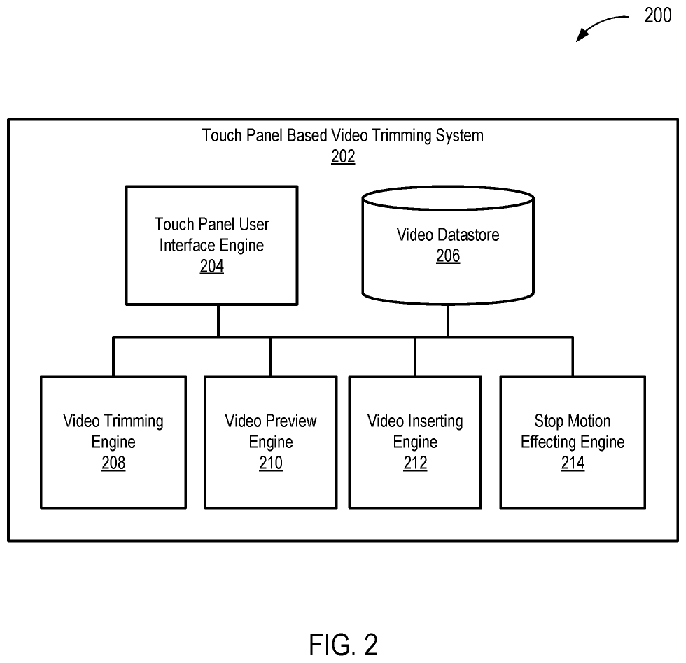

FIG. 2 depicts a diagram 200 of an example of a touch panel based video trimming system 202. The touch panel based video trimming system 202 includes a touch panel user interface engine 204, a video datastore 206, a video trimming engine 208, a video preview engine 210, a video inserting engine 212, and a stop motion effecting engine 214.

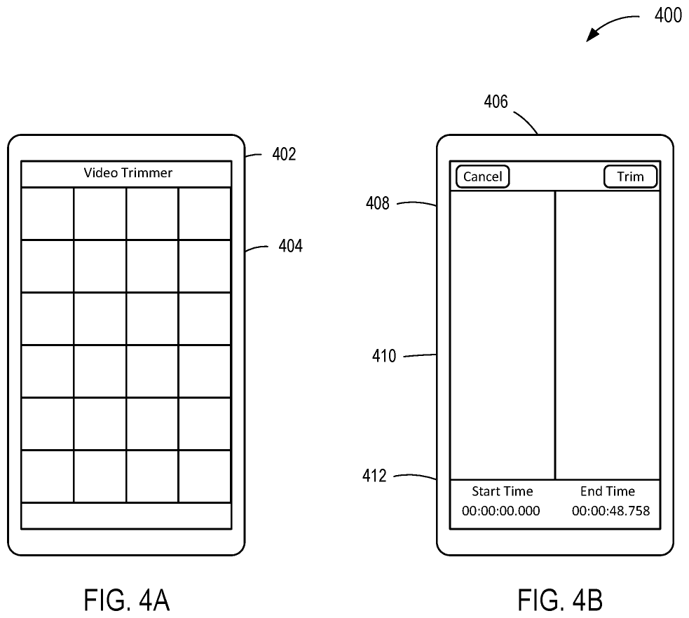

In the example of FIG. 2, the touch panel user interface engine 204 is intended to represent a hardware configured to display touch panel user interfaces on a display associated with the touch panel based video trimming system 202 and receive user touch operations on the displayed touch panel user interfaces. The touch panel user interfaces controlled to be displayed by the touch panel user interface engine 204 may include touch panel user interfaces shown in FIGS. 4 and 6-9.

In the example of FIG. 2, the video datastore 206 is intended to represent datastore configured to store video files and other contents files (e.g., audio, still images, etc.) imported into or created at the touch panel based video trimming system 202. For example, the touch panel user interface engine 204 pulls up a video file from the video datastore 206 to display contents associated with the pulled-up video file. In another example, the video trimming engine 208 stores a trimmed video file in the video datastore 206.

In the example of FIG. 2, the video trimming engine 208 is intended to represent a hardware configured to trim video contents of a video file in accordance with touch operations received by the touch panel user interface engine 204. In a specific implementation, in trimming video contents of a video file, the video trimming engine 208 causes the touch panel user interface engine 204 to generate and display a touch panel user interface for selecting a video file to be trimmed and selects a video file to be trimmed based on a touch operation to select the video file on the touch panel user interface for selecting the video file to be trimmed. An example of the touch panel user interface for selecting a video file to be trimmed is shown in FIG. 4A. In a specific implementation, in trimming video contents of a video file, the video trimming engine 208 causes the touch panel user interface engine 204 to generate and display a touch panel user interface for trimming a selected video file, and trims the video contents of the selected video file based on one or more touch operations to select a part of the video contents to be trimmed on the user interface for trimming the selected video file. An example of the touch panel user interface for trimming a video file is shown in FIG. 4B.

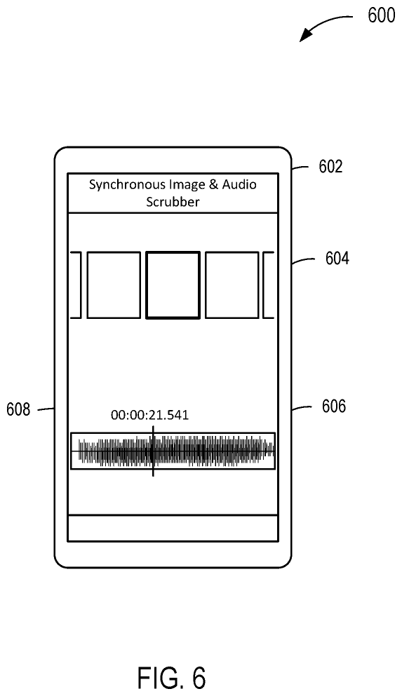

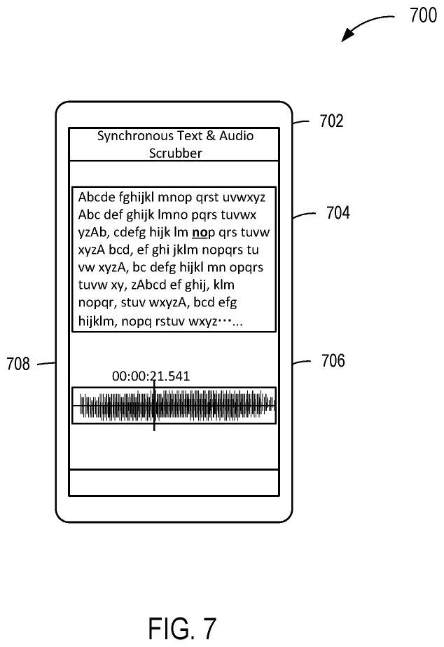

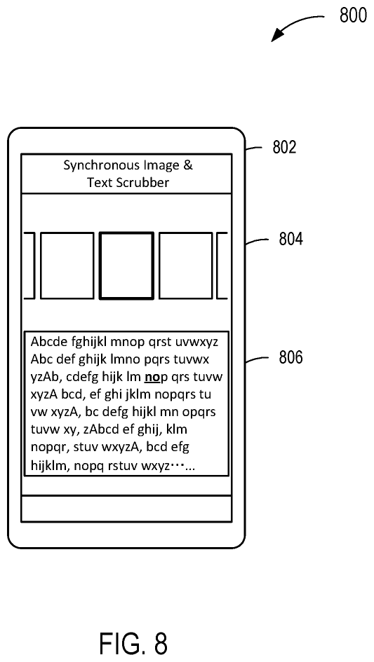

In the example of FIG. 2, the video preview engine 210 is intended to represent a hardware configured to allow for preview of video contents of a video file in accordance with touch operations received by the touch panel user interface engine 204. In a specific implementation, for preview of video contents of a video file, the video preview engine 210 causes the touch panel user interface engine 204 to generate and display a touch panel user interface for synchronously previewing image and audio contents of a video file. An example of the touch panel user interface for synchronously previewing image and audio contents of a video file is shown in FIG. 6. In a specific implementation, for preview of video contents of a video file, the video preview engine 210 causes the touch panel user interface engine 204 to generate and display a touch panel user interface for synchronously previewing script and audio contents of a video file. An example of the touch panel user interface for synchronously previewing script and audio contents of a video file is shown in FIG. 7. In a specific implementation, for preview of video contents of a video file, the video preview engine 210 causes the touch panel user interface engine 204 to generate and display a touch panel user interface for synchronously previewing image and script contents of a video file. An example of the touch panel user interface for synchronously previewing image and script contents of a video file is shown in FIG. 8.

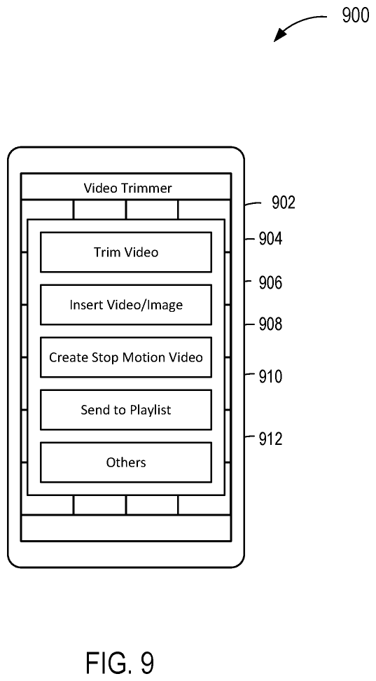

In the example of FIG. 2, the video inserting engine 212 is intended to represent a hardware configured to insert media contents such as a video contents, image contents, and/or audio contents, into a target video file in accordance with touch operations received by the touch panel user interface engine 204. In a specific implementation, in inserting media contents, the video inserting engine 212 causes the touch panel user interface engine 204 to generate and display a touch panel user interface for selecting operations to perform on a touch panel based video trimming system. An example of the touch panel user interface for selecting an operation to be performed is shown in FIG. 9. In a specific implementation, in inserting media contents, the video inserting engine 212 starts an operation to insert contents in response to a touch operation on the touch panel user interface for selecting an operation to be performed.

In the example of FIG. 2, the stop motion effecting engine 214 is intended to represent a hardware configured to create a stop motion video from a video file in accordance with touch operations received by the touch panel user interface engine 204. A stop motion video in this paper is intended to mean digitally-created video contents with a reduced frame rate as if the video contents were a sequence of still images captured while objects in the video contents move or are moved manually. In a specific implementation, in creating a stop motion video, the stop motion effecting engine 214 causes the touch panel user interface engine 204 to generate and display a touch panel user interface for selecting operations to perform on a touch panel based video trimming system. In a specific implementation, in creating a stop motion video, the stop motion effecting engine 214 starts an operation to create a stop motion video in response to a touch operation on the touch panel user interface for selecting an operation to be performed.

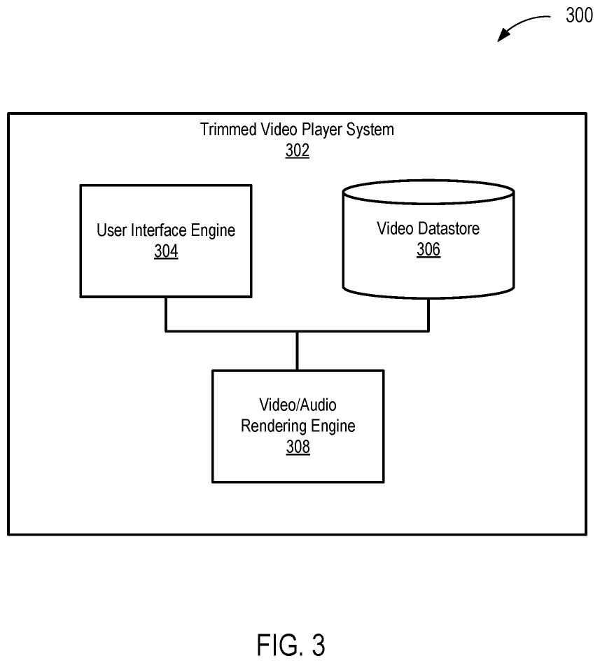

FIG. 3 depicts a diagram 300 of an example of a trimmed video player system 302. The trimmed video player system 302 includes a user interface engine 304, a video datastore 306, and a video/audio rendering engine 308.

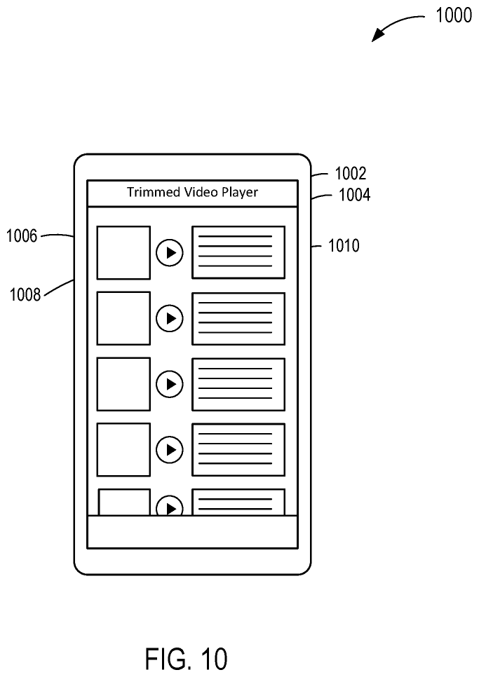

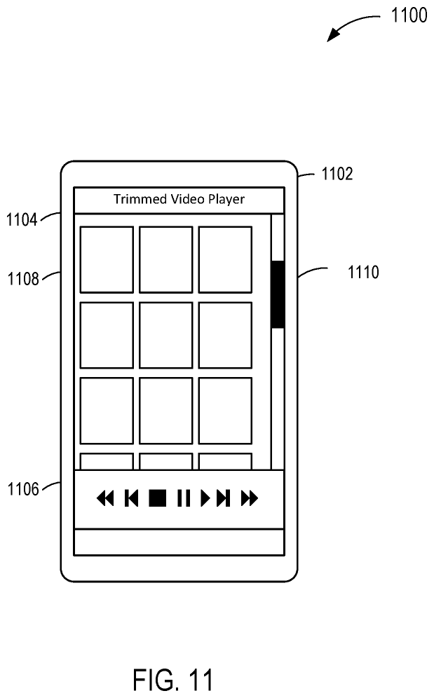

In the example of FIG. 3, the user interface engine 304 is intended to represent a hardware configured to display user interfaces on a display associated with the trimmed video player system 302 and receive user operations on the displayed user interfaces. The user interfaces controlled to be displayed by the user interface engine 304 may include user interfaces shown in FIGS. 10-11. Depending upon implementation-specific or other considerations, the user interfaces controlled to be displayed by the user interface engine 304 may be touch panel user interfaces or non-touch panel user interfaces.

In the example of FIG. 3, the video datastore 306 is intended to represent datastore configured to store video files downloaded or streaming from a trimmed video management system. For example, the video/audio rendering engine 308 pulls up a video file from the video datastore 306 to enable the user interface engine 304 to display contents associated with the pulled-up video file.

In the example of FIG. 3, the video/audio rendering engine 308 is intended to represent a hardware configured to render video/audio contents of a video file for the user interface engine 304 to present the rendered contents. In a specific implementation, in rendering video/audio contents of a video file, the video/audio rendering engine 308 causes the user interface engine 304 to generate and display a user interface for selecting a video file to playback on the trimmed video player system 302. An example of the user interface for selecting a video file to playback on the trimmed video player system 302 is shown in FIG. 10. In a specific implementation, in rendering video/audio contents of a video file, the video/audio rendering engine 308 causes the user interface engine 304 to further generate and display a user interface for concurrently playing a video file and reviewing image contents of the video file. An example of the user interface for concurrently playing a video file and reviewing image contents of the video file is shown in FIG. 11.

FIG. 4A and FIG. 4B depict an example 400 of a touch panel user interface for selecting and trimming a video file. FIG. 4A shows a touch panel user interface for selecting a video file and FIG. 4B shows a touch panel user interface for trimming a video file. A touch panel user interface can include one or more graphical user interfaces (GUIs), physical buttons, scroll wheels, and the like, associated with one or more mobile computing devices (e.g., the one or more mobile computing devices implementing the functionality of a dynamic optical code generation system). The touch panel user interface for selecting a video file and the touch panel user interface for trimming a video file are suitably displayed on a touch panel screen of applicable computing systems, for example, a touch panel based video trimming system described in this paper. In particular, for example, when primary user operations on the computing systems are performed by touch operations, the touch panel user interfaces in the example 400 can allow for more user friendly video selection and video trimming operations.

In the example of FIG. 4A, the touch panel user interface for selecting a video file includes a header region 402 and a video selection region 404. The header region 402 is intended to represent a touch panel user interface region configured to display general information of an application based on which the touch panel user interface is caused to be displayed. The general information may include a title of the application (e.g., video trimmer), and any other applicable metadata about the application, such as a version number. Depending upon implementation-specific or other considerations, the header region 402 may include one or more selectable objects for applicable operations, such as going back to a previous touch panel user interface and proceeding to a setting for the application.

The video selection region 404 is intended to represent a touch panel user interface region configured to display one or more selectable objects corresponding to one or more video files. In a specific implementation, a selectable object in the video selection region 404 includes a represented frame image of a corresponding video file, such as a start frame image, a designated frame image, or a representative computer graphic image of a video file. For example, the designated frame image may be selected by a user from frame images of the video file, automatically determined based on an artificial intelligence (AI), or any other applicable methods.

In a specific implementation, in response to selection of one of the one or more selectable objects, the touch panel user interface for selecting a video file transitions to another touch panel user interface for trimming a video file corresponding to the selected object (hereinafter referred to as a selected video file), such as the touch panel user interface for trimming a video file shown in FIG. 4B. In a specific implementation, one or more video files of which selectable objects are presented in the video selection region 404 are imported from internal datastore of a touch panel based video trimming system or external datastore of the touch panel based video trimming system.

In the example of FIG. 4B, the touch panel user interface for trimming a video file includes a header region 406, a start time selection region 408, an end time selection region 410, and a footer region 412. In the example of FIG. 4B, the header region 406 has the same or similar functionality as the header region 402 of the touch panel user interface for selecting a video file. The header region 406 includes a selectable object to cancel an operation trimming a video file (e.g., indicated as “Cancel”) and a selectable object to confirm a trimmed video file (e.g., indicated as “Trim”).

In the example of FIG. 4B, the start time selection region 408 is intended to represent a touch panel user interface region configured to display at least a part of a start frame image of a selected video file. When no trim operation has been carried out on the selected video file, the start frame image is an initial frame image of the selected video file at the start time (e.g., 00:00:00.000). In a specific implementation, when an aspect ratio of the start time selection region 408 does not correspond to an aspect ratio of frame images of the selected video file, a part of the start frame image is displayed in the entire region of the start time selection region 408. The part of the start frame image may be a center portion, an end portion (e.g., left end or right end), or a selected portion (e.g., by the user or by the application) of the start frame image. In another specific implementation, when the aspect ratio of the start time selection region 408 does not correspond to the aspect ratio of frame images of the selected video file, a shrunk start frame image of the selected video file is displayed along with filling portions (e.g., blank portions) on the start time selection region 408.

The start frame image of the selected video file can be changed based on a touch operation on the start time selection region 408. In a specific implementation, the touch operation includes a swipe operation in a transverse direction. When the start frame image is changeable by a swipe operation, swiping in one direction (e.g., right direction) shifts a displayed frame image to a reverse direction in a time frame of the selected video file, and swiping in an opposite direction (e.g., left direction) shifts the displayed frame image to a forward direction in the time frame. For example, when no trim operation has been carried out on the selected video file, the swipe operation works only in the forward direction. For example, when the start frame image is shifted to the last frame image of the video file, an error notification may be displayed on the start time selection region 408 along with or instead of the last frame image.

In a specific implementation, the touch operation includes a flick operation in the same direction as a swipe operation to skip frame images corresponding to a strength of the flick operation. In a specific implementation, the touch operation includes a pinch operation and a spread operation to enlarge and shrink a size of the displayed frame image. In a specific implementation, a single tap operation is sufficient to each of enlarge and shrink a size of the displayed frame image.

In the example of FIG. 4B, the end time selection region 410 is intended to represent a touch panel user interface region configured to display at least a part of an end frame image of a selected video file. The end time selection region 410 functions in the same or similar manner as the start time selection region 408. In a specific implementation, when no trim operation has been carried out on the selected video file, the end frame image is a last frame image of the selected video file at the end time (e.g., 00:00:48.758). The end frame image of the selected video file can be changed based on the touch operation in the same manner as the start time selection region 408.

In a specific implementation, the start time selection region 408 and the end time selection region 410 are independently operable, in that change of a start frame image and change of an end frame image can be made mutually independently. In a specific implementation, the start time selection region 408 and the end time selection region 410 are synchronously operable, in that change of a start frame image and change of an end frame image cannot be made mutually independently. For example, when a user wants to create a video file of a specific period of time (e.g., 15 sec), the synchronous change of the start and end frame images may be useful.

In a specific implementation, a size of the start time selection region 408 and the end time selection region 410 is changeable. For example, a split line that separates the start time selection region 408 and the end time selection region 410 (a center vertical line in FIG. 4B) is movable in a direction to change the size of the start time selection region 408 and the end time selection region 410.

In a specific implementation, the start time selection region 408 and the end time selection region 410 may display a start frame image and an end frame image of a video portion to be trimmed. For example, when a portion of a video file to be trimmed is a mid-part of the video file, this functionality of the start time selection region 408 and the end time selection region 410 enables the trimming in the mid-part of the video file.

In the example of FIG. 4B, the footer region 412 is intended to represent a touch panel user interface region configured to display a start time and an end time of the selected video file. When no trim operation has been carried out on the selected video file, the start time and the end time coincide with the start time and the end time of the non-trimmed selected video file. In accordance with change of the start frame image and the end frame image on the start time selection region 408 and the end time selection region 410, respectively, the start time and the end time on the footer region 412 can change to indicate the corresponding time of the selected start frame image and/or the selected end image.

In a specific implementation, when the start frame image and the end frame image are changed as the user likes, the user can select the selectable object in the header region 406 to confirm a trimmed video file starting from the selected start frame image and ending at the selected end frame image. The trimmed video file is generated and stored in applicable datastore associated with a touch panel based video trimming system. A selectable object corresponding to the generated trimmed video file may be added to the video selection region 404, such that the generated trimmed video file can be instantly played back to check the created video contents. Depending upon implementation-specific or other considerations, the original non-trimmed video file may or may not be deleted upon creation of the trimmed video file.

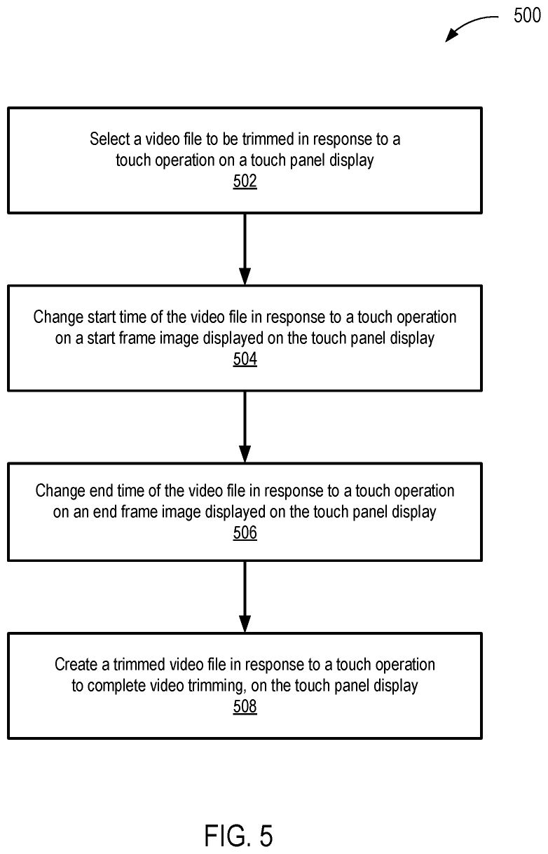

FIG. 5 depicts a flowchart 500 of an example method for selecting and trimming a video file. In this and other flowcharts described in this paper, the flowchart illustrates by way of example a sequence of modules. It should be understood the modules can be reorganized for parallel execution, or reordered, as applicable. Moreover, some modules that could have been included may have been removed to avoid providing too much information for the sake of clarity and some modules that were included could be removed, but may have been included for the sake of illustrative clarity.

In the example of FIG. 5, the flowchart 500 starts at module 502 with selecting a video file to be trimmed in response to a touch operation on a touch panel display. In a specific implementation, a video file to be trimmed is selected from one or more video files imported into an applicable datastore associated with a touch panel based video trimming system based on a selection of a corresponding representative selectable object on a user interface by the touch operation (e.g., tap operation).

In the example of FIG. 5, the flowchart 500 continues to module 504 with changing a start time of the video file to be trimmed in response to a touch operation on a start frame image displayed on the touch panel display. Depending upon implementation-specific or other considerations, the start time can be forwarded to a forwarded time to trim an unnecessary portion of the video file between the start time and the forwarded time.

In the example of FIG. 5, the flowchart 500 continues to module 506 with changing end time of the video file in response to a touch operation on an end image displayed on the touch panel display. Depending upon implementation-specific or other considerations, the end time can be reversed to a reversed time to trim an unnecessary portion of the video file between the reversed time and the end time. In a specific implementation, only one of the module 502 and the module 504, and not both, may be carried out.

In the example of FIG. 5, the flowchart 500 continues to module 508 with creating a trimmed video file in response to a touch operation to complete video trimming, on the touch panel display. Depending upon implementation-specific or other considerations, the created trimmed video file may be locally stored in datastore associated with a touch panel based video trimming system, sent to a designated trimmed video player system for playback of the trimmed video file, or uploaded to a trimmed video management system for publishing the trimmed video file.

FIG. 6 depicts an example 600 of a touch panel user interface for synchronously previewing image and audio contents of a video file. In the example of FIG. 6, the touch panel user interface for synchronously previewing image and audio contents of a video file includes a header region 602, a frame image display region 604, and an audio scrubbing region 606. The touch panel user interface for synchronously previewing image and audio contents of a video file is suitably displayed on a touch panel screen of applicable computing systems, for example, a touch panel based video trimming system described in this paper. The header region 602 functions to display general information of an application, such as functionality of the displayed touch panel user interface.

In the example of FIG. 6, the frame image display region 604 is intended to represent a touch panel user interface region configured to display a sequence of frame images of a selected video file in the chronological order of the video file. The frame image display region 604 may be referred to as an image slider. The selected video file may be a non-trimmed video file, or a trimmed video file generated according to a trim operation such as the one described above. Typically, the leftmost frame image of the sequence is the start frame image of the selected video file and the rightmost frame image of the sequence is the end frame image of the selected video file. In a specific implementation, a selected frame image, one or more frame images preceding the selected frame image, and one or more frame images following the selected frame image are displayed in the frame image display region 604. In another specific implementation, a selected frame image is large enough and one or more adjacent frame images may not be displayed. Depending upon implementation-specific or other considerations, the selected frame image is displayed at a center of the frame image display region 604 with an emphasis (e.g., bold frame, a larger size, etc.).

The selected frame image of the selected video file can be changed based on a touch operation on the frame image display region 604. In a specific implementation, the touch operation includes a swipe and/or flick operation in a transverse direction. For example, swiping in one direction (e.g., right direction) shifts a displayed frame image to a reverse direction in a time frame of the selected video file, and swiping in an opposite direction (e.g., left direction) shifts the displayed frame image to a forward direction in the time frame. Depending upon implementation-specific or other considerations, the selected video file can be played back from the selected frame image.

In the example of FIG. 6, the audio scrubbing region 606 is intended to represent a touch panel user interface region configured to display a sequence of audio waveforms of a selected video file in a time domain. The audio scrubbing region 606 includes an indicator 608 to indicate a selected time point, which may correspond to the time point of the selected frame image in the frame image display region 604. Typically, the leftmost part of the audio scrubbing region 606 corresponds to the start time of the selected video file and the rightmost part of the audio scrubbing region 606 corresponds to the end time of the selected video file. Depending upon implementation-specific or other considerations, the indicator 608 may shift as playback time proceeds. Depending upon implementation-specific or other considerations, the indicator 608 is in applicable shape, for example, a vertical line as shown in FIG. 6.

The position of the indicator 608 of the audio scrubbing region 606 can be changed based on a touch operation on the frame image display region 604. In a specific implementation, the touch operation includes a swipe operation in a time direction of the audio scrubbing region 606.

In a specific implementation, the selected frame image in the frame image display region 604 and the indicator 608 in the audio scrubbing region 606 synchronously shift. For example, as the selected frame image in the frame image display region 604 is changed in a forward direction according to a touch operation thereof, the indicator 608 in the audio scrubbing region 606 moves in a forward direction. In another example, as the indicator 608 in the audio scrubbing region 606 is moved in a reverse direction according to a touch operation thereof, the selected frame image in the frame image display region 604 shifts in a reverse direction.

In the audio scrubbing region 606, a time point indicator corresponding to the indicator 608 is indicated adjacent to the indicator 608. In a specific implementation, when a touch operation is performed with respect to the indicator 608, the time point indicator may be shifted so as not to be covered by a touching part (e.g., finger, stylus, etc.) manipulated by a user. For example, by detecting a shape and an angle of a touching finger detected by a touch panel, whether the touching finger is of a left hand or a right hand is determined, and the time point indicator is moved to a region that is not likely to be covered by the hand of the determined side. More specifically, when the touching finger is determined to be of a right hand, the time point indicator is shifted to a left direction so as not to be covered by the right hand. Depending upon implementation-specific or other considerations, the shifted time point indicator may be returned to the original position or stay at the shifted position after it is determined that a touch operation of the indicator 608 is no longer carried out.

FIG. 7 depicts an example 700 of a touch panel user interface for synchronously previewing script and audio contents of a video file. In the example of FIG. 7, the touch panel user interface for synchronously previewing script and audio contents of a video file includes a header region 702, a script display region 704, and an audio scrubbing region 706. The touch panel user interface for synchronously previewing script and audio contents of a video file is suitably displayed on a touch panel screen of applicable computing systems, for example, a touch panel based video trimming system described in this paper. The header region 702 functions to display general information of an application, such as functionality of the displayed touch panel user interface.

In the example of FIG. 7, the script display region 704 is intended to represent a touch panel user interface region configured to display a script generated from audio contents of a selected video file according to a computer-based voice recognition technology. The script display region 704 may be referred to as a text scrubber. The selected video file may be a non-trimmed video file, or a trimmed video file generated according to a trim operation such as the one described above. Typically, the upper left text corresponds to first voice data of the selected video file and the lower right text corresponds to last voice data of the selected video file. In a specific implementation, when the script is longer than the script display region 704, the script display region 704 is caused to be scrollable to show the intended part of the script. In a specific implementation, a selected text is indicated in the script display region 704 with emphasis (e.g., bold font, under line, highlight, etc.) Depending upon implementation-specific or other considerations, text is selectable in units of one or more of a letter, a syllable, a word, and so on.

The selected text of the script can be changed based on a touch operation on the script display region 704. In a specific implementation, the touch operation includes a tap operation on the text to be selected and a following swiping operation. For example, tapping of a character and swiping in one direction (e.g., right direction) selects a syllable or a word including the character that has been tapped. Depending upon implementation-specific or other considerations, the selected video file can be played back from the selected text.

In the example of FIG. 7, the audio scrubbing region 706, and an indicator 708 included therein, function in the same or similar manner as the audio scrubbing region 606 and the indicator 608 in FIG. 6, respectively. In a specific implementation, the selected text in the script display region 704 and the indicator 708 in the audio scrubbing region 706 synchronously shift. For example, as the selected text in the script display region 704 is changed according to a touch operation thereof, the indicator 708 in the audio scrubbing region 706 moves in accordance with the change of the selected text. In another example, as the indicator 708 in the audio scrubbing region 706 is moved according to a touch operation thereof, the selected text in the script display region 704 changes.

FIG. 8 depicts an example 800 of a touch panel user interface for synchronously previewing image and script contents of a video file. In the example of FIG. 8, the touch panel user interface for synchronously previewing image and script contents of a video file includes a header region 802, a frame image display region 804, and a script display region 806. The touch panel user interface for synchronously previewing image and script contents of a video file is suitably displayed on a touch panel screen of applicable computing systems, for example, a touch panel based video trimming system described in this paper. The header region 802 functions to display general information of an application, such as functionality of the displayed touch panel user interface.

In the example of FIG. 8, the frame image display region 804 functions in the same or similar manner as the frame image display region 604 in FIG. 6. In the example of FIG. 8, the script display region 806 functions in the same or similar manner as the script display region 704 in FIG. 7. In a specific implementation, a selected frame image in the frame image display region 804 and a selected text in the script display region 806 synchronously shift. For example, as the selected frame image in the frame image display region 804 is changed according to a touch operation thereof, the selected text in the script display region 806 moves in accordance with the change of the selected frame image. In another example, as the selected text in the script display region 806 is moved according to a touch operation thereof, the selected frame image in the frame image display region 804 changes.

Although the above examples show synchronous shift of two display regions in touch panel user interfaces, three or more display regions may be synchronized. For example, a frame image display region, an audio scrubbing region, and a script display region may be synchronized such that a selected frame image, an indicator, and a selected text synchronously changes in accordance with a touch operation of one of the selected frame image, the indicator, and the selected text.

FIG. 9 depicts an example 900 of a touch panel user interface for selecting an operation to be performed on a touch panel based video trimming system. In the example of FIG. 9, the touch panel user interface for selecting operations to perform on a touch panel based video trimming system includes an operation selection region 902. In a specific implementation, the touch panel user interface for selecting an operation to be performed is pulled up in response to selection of a video file on a touch panel user interface for selecting a video file, and displayed over the touch panel user interface for selecting a video file. In another specific implementation, the touch panel user interface for selecting an operation to be performed is pulled up in response to selection of a frame image on applicable user interfaces such as the user interfaces shown in FIGS. 6 and 8.

In the example of FIG. 9, the operation selection region 902 includes one or more of a trim video object 904, an insert video/audio object 906, a create stop motion video object 908, an upload object 910, and another functionality selection object 912, depending on an operational state when the operation selection region 902 is pulled up. The trim video object 904, the insert video/audio object 906, the create stop motion video object 908, the upload object 910, and the other selection object 912 are operable by a touch operation, such as a tap operation on the displayed user interface.

The trim video object 904 is a selectable object to start a trim operation, such as the trim operation described above. The insert video/audio object 906 is a selectable object to start an operation to insert a video file or one or more frame images into a target video file. As a result of the insertion, a new video file combining the target video file and the inserted video file or frame images can be created. The create stop motion video object 908 is a selectable object to create a stop motion video from a selected video file. In a specific implementation, to create a stop motion video, frame images are extracted from the selected video file such that a sequence of frame images are at a reduced number per unit time (e.g., 10-12 fps) compared to original number (e.g., 120, 240, 300 fps). The upload object 910 is a selectable object to upload a crated video file (e.g., a trimmed video file) to a playlist where the created video file can be rendered for display. The other selection object 912 is a selectable object to select the other functionalities with respect to a selected video file or a selected frame image thereof. For example, the other functionalities may include setting of a video playback speed, setting of a theme for playing back a video file, setting of resolution (e.g., 240p (SD), 480p, 720p (half HD), 1080 (full HD), 2160 (4K), etc.), and so on. According to the operation selection region 902, an intended functionality can be performed with a less number of touch operations (e.g., one or two touch operations) compared to a conventional application for manipulating video files on a touch panel based system.

FIG. 10 depicts an example 1000 of a user interface for selecting a video file to playback on a trimmed video player system. In the example of FIG. 10, the user interface for selecting a video file to play on a trimmed video player system includes a header region 1002 and a video file selection region 1004. The user interface for selecting a video file to playback is suitably displayed on a trimmed video player system described in this paper. The header region 1002 functions to display general information of an application, such as functionality of the displayed touch panel user interface.

In the example of FIG. 10, the video file selection region 1004 includes a video thumbnail display region 1006, a playback command region 1008, and a video description region 1010. The video thumbnail display region 1006 is intended to represent a touch panel user interface region configured to display a thumbnail image representing a video file. The playback command region 1008 is intended to represent a touch panel user interface region configured to display a selectable object to pull up a play controller for controlling a played back video contents. The video description region 1010 is intended to represent a touch panel user interface region configured to display metadata of the corresponding video file, such as a title, an updated date, summary, an author, and so on.

FIG. 11 depicts an example 1100 of a user interface for concurrently playing a video file and reviewing image contents of the video file. In the example of FIG. 11, the user interface for concurrently playing a video file and reviewing image contents of the video file includes a header region 1102, a frame image display region 1104, and a playback control region 1106. The user interface for concurrently playing a video file and reviewing image contents of the video file is suitably displayed on a trimmed video player system described in this paper after a video file to be played back has been selected on a user interface such as the user interface for selecting a video file to playback described in this paper.

In the example of FIG. 11, the frame image display region 1104 includes a plurality of frame images 1108 of a video file and a scroll bar 1110. The plurality of frame images 1108 are arranged in the order of the video contents of the selected video file. Although the plurality of frame images 1108 are displayed in a grid of panels, depending upon implementation-specific or other considerations, the plurality of frame images 1108 may be displayed in other display manners, such as an image slider described in this paper. The scroll bar 1110 functions to scroll up and down the plurality of frame images 1108.

In the example of FIG. 11, the playback control region 1106 is intended to represent a touch panel user interface region configured to display a plurality of selectable objects to control a playback of the video contents of the selected video file. In a specific implementation, the playback control region 1106 includes one or more of selectable objects to start, stop, pause, next, fast forward, previous, and rewind, and so on.

In a specific implementation, the plurality of frame images 1108 in the frame image display region 1104 can be scrubbed without interrupting a played back video. More specifically, audio contents of the played back video can be reproduced while the frame image display region 1104 is being displayed on the user interface for concurrently playing a video file and reviewing image contents of the video file. This functionality enables a user to review frame images of a video file independently from reproduction of the audio contents thereof on the touch panel display. In a specific implementation, upon detecting that a user is no longer carrying out the scrubbing of the plurality of frame images 1108 in the frame image display region 1104, the user interface transitions to video contents corresponding to the played-back audio contents. Depending upon implementation-specific or other considerations, a predetermined amount (e.g., 3-8 sec) of non-operation on the user interface may be needed for the detection.

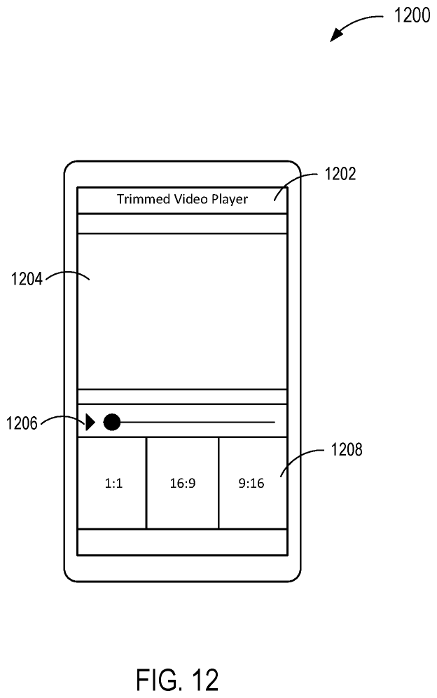

FIG. 12 depicts an example of a user interface for adjusting an aspect ratio of a screen to playback a video file. In the example of FIG. 12, the user interface for adjusting an aspect ratio includes a header region 1202, a frame image display region 1204, a playback control region 1206, and an aspect ratio control region 1208. The header region 1202, the frame image display region 1204, and the playback control region 1206 function in the same or substantially similar manner to the header region 1102, the frame image display region 1104, and the playback control region 1106 in FIG. 11.

In the example of FIG. 12, the aspect ratio control region 1208 includes one or more selectable objects to select an aspect ratio of a screen to playback a video file in the frame image display region 1204. In each of the one or more selectable objects indicates the corresponding aspect ratio of the screen, and the aspect ratio of the screen displayed in the frame image display region 1204 switches to the selected aspect ratio. The number of the selectable objects and the specific aspect ratios are not limited, and applicable number of selectable objects and applicable aspect ratios can be selected.

In the example of FIG. 12, the frame image display region can be engaged (e.g., by touching a touchscreen overlaying the region), to move within the new aspect ratio. When moving within the region, the movement is recorded and the video is updated in accordance with movement within the region while the audio continues to play. Advantageously, switching between aspect ratios and recording the view within the new aspect ratio is accomplished via a single graphical user interface.

For purposes of explanation, numerous specific details are set forth in order to provide a thorough understanding of the description. It will be apparent, however, to one skilled in the art that implementations of the disclosure can be practiced without these specific details. In some instances, systems, modules, engines, structures, processes, features, and devices are shown in block diagram form in order to avoid obscuring the description. In other instances, functional block diagrams and flow diagrams are shown to represent data and logic flows. The components of block diagrams and flow diagrams (e.g., steps, modules, blocks, structures, devices, features, etc.) may be variously combined, separated, removed, reordered, and replaced in a manner other than as expressly described and depicted herein.

The language used herein has been principally selected for readability and instructional purposes, and it may not have been selected to delineate or circumscribe the inventive subject matter. It is therefore intended that the scope be limited not by this detailed description, but rather by any claims that issue on an application based hereon. Accordingly, the disclosure of the implementations is intended to be illustrative, but not limiting, of the scope, which is set forth in the claims recited herein. The techniques described in the preceding text and figures can be mixed and matched as circumstances demand to produce alternative implementations.

1. A method for selecting and trimming a video file, the method comprising:
selecting a video file to be trimmed in response to a touch operation on a touch panel display;
changing a start time of the video file in response to a touch operation on a start frame image displayed on the touch panel display;
changing an end time of the video file in response to a touch operation on an end frame image displayed on the touch panel display;
creating a trimmed video file in response to a touch operation on the touch panel display to complete video trimming.

2. The method of claim 1, further comprising forwarding the start time to a forwarded time to trim a portion of the video file between the start time and the forwarded time.

3. The method of claim 1, further comprising reversing the end time to a reversed time to trim a portion of the video file between the reversed time and the end time.

4. The method of claim 1, further comprising selecting a duration of the trimmed video file, wherein changing the start time of the video file causes the end time of the video file to be automatically selected based on the selected duration of the trimmed video file, or changing the end time of the video file causes the start time of the video file to be automatically selected based on the selected duration of the video file.

5. The method of claim 1, further comprising storing the trimmed video file in a local datastore.

6. The method of claim 1, further comprising sending the trimmed video file to a video player system for playback of the trimmed video file or to a video management system for publishing of the trimmed video file.

7. The method of claim 1, further comprising displaying a preview of script content of the video file or video content of the video file in response to a touch operation on the touch panel display.

8. The method of claim 1, further comprising synchronously displaying a preview of script content of the video file or image content of the video file and audio content of the video file in response to a touch operation on the touch panel display.

9. The method of claim 1, further comprising synchronously displaying a preview of script content of the video file and image content of the video file in response to a touch operation on the touch panel display.

10. The method of claim 1, wherein the touch panel display is a component of a smartphone, a cell phone, a smartwatch, a tablet computer, a laptop computer, or a desktop computer.

11. A system comprising:
a touch panel display;
a touch panel user interface engine configured to display touch panel user interfaces on the touch panel display and to receive user touch operations on the displayed touch panel user interfaces;
a video trimming engine configured to:
cause the touch panel user interface engine to generate and present, on the touch panel display, a touch panel user interface for selecting a video file to be trimmed,
select a video file to be trimmed in response to a first touch operation on the touch panel user interface,
change a start time of the video file in response to a second touch operation on a start frame image displayed on the touch panel user interface,
change an end time of the video file in response to a third touch operation on an end frame image displayed on the touch panel user interface,
create a trimmed video file in response to a fourth touch operation on the touch panel user interface to complete video trimming.

12. The system of claim 11, wherein the video trimming engine is configured to forward the start time to a forwarded time to trim a portion of the video file between the start time and the forwarded time.

13. The system of claim 11, wherein the video trimming engine is configured to reverse the end time to a reversed time to trim a portion of the video file between the reversed time and the end time.

14. The system of claim 11, wherein the video trimming engine is configured to select a duration of the trimmed video file, wherein changing the start time of the video file causes the end time of the video file to be automatically selected based on the selected duration of the trimmed video file, or changing the end time of the video file causes the start time of the video file to be automatically selected based on the selected duration of the video file.

15. The system of claim 11, wherein the video trimming engine is configured to store the trimmed video file in a local datastore.

16. The system of claim 11, wherein the video trimming engine is configured to send the trimmed video file to a video player system for playback of the trimmed video file or to a video management system for publishing of the trimmed video file.

17. The system of claim 11, wherein the video trimming engine is configured to display a preview of script content of the video file or video content of the video file in response to a touch operation on the touch panel display.

18. The system of claim 11, wherein the video trimming engine is configured to synchronously display a preview of script content of the video file or image content of the video file and audio content of the video file in response to a touch operation on the touch panel display.

19. The system of claim 11, wherein the video trimming engine is configured to synchronously display a preview of script content of the video file and image content of the video file in response to a touch operation on the touch panel display.

20. The system of claim 11, wherein the touch panel display is a component of a smartphone, a cell phone, a smartwatch, a tablet computer, a laptop computer, or a desktop computer.
